(19) United States
(12) Patent Application Publication
(10) Pub. No.: US 2006/0037772 A1
(43) Pub. Date: Feb. 23, 2006

(54) Conductor feedthrough and method of manufacture therefor

(76) Inventor: Edward Douglas, Randolph, NJ (US)

Correspondence Address: WOLFF & SAMSON, P.C., ONE BOLAND DRIVE, WEST ORANGE, NJ, 07052, US

(21) Appl. No.: 11/149,503

(22) Filed: Jun. 9, 2005

Related U.S. Application Data
(60) Provisional application No. 60/579,076, filed on Jun. 10, 2004.

(51) Int. Cl. H02G 15/04

(52) U.S. Cl. 174/65 G

(57) ABSTRACT

A conductor feedthrough is provided for allowing an electrical conductor, cable, wire, etc., to be passed through a wall of a pressurized vessel (e.g., a compressor vessel forming part of a refrigeration or air conditioning system) while maintaining a hermetic seal within the vessel and providing resistance to mechanical stress imparted on the conductor. The feedthrough comprises a first casting formed on a portion of a conductor, a fitting engageable with the first casting and inserted into an aperture in a vessel wall, and a second casting formed on an end of the first casting. The fitting is engaged with the first casting in such a manner as to prevent relative rotational movement between the first casting and the fitting. The feedthrough maintains a hermetic seal within the vessel and locks the conductor in place to provide resistance to mechanical stress and/or torque applied to the conductor.

### RELATED APPLICATIONS

This application claims the priority of U.S. Provisional Patent Application No. 60/579,076 filed Jun. 10, 2004.

### BACKGROUND OF THE INVENTION

1. Field of the Invention

The present invention relates to a feedthrough for electrical conductors. More specifically, the present invention relates to a feedthrough for allowing an electrical conductor to pass through a wall of a pressurized vessel while maintaining a hermetic seal and providing resistance to torque stress imparted on the feedthrough.

2. Related Art

A number of mechanisms have in the past been designed for allowing electrical conductors, cables, and wires to be passed through a wall of an enclosure. A common example is a grommet, which allows a conductor to be passed through a wall of an electrical enclosure box while providing protection against damage to the conductor resulting from mechanical stress while the device is in use. Other examples of feedthroughs include strain reliefs, which are also commonly employed with power cables and enclosures.

Other feedthroughs have been designed for allowing a conductor to be passed through the walls of a pressurized vessel, such as a compressor vessel forming part of an air conditioning or refrigeration system. In such systems, hermetic seals must be capable of withstanding pressures greater than 2,000 psi without allowing the formation of air bubbles on the external side of the vessel after being exposed to the atmosphere for 20 minutes. In one example, a conductor is passed through a brass or stainless steel fitting positioned in an aperture in the wall of the vessel. The conductor is then hermetically sealed to the fitting using an epoxy casting formed on the conductor and an elastomeric material forming a bond between the casting and the inner wall of the fitting.

While such an arrangement provides for a hermetic seal and allows electrical power to be delivered into the vessel, mechanical stresses of greater than 30 to 40 foot-pounds of torque imparted on the conductor result in damage to the elastomer. As a result, the hermetic seal can be compromised. Moreover, excessive torque applied to the conductor can result in failure of the dielectric to provide electrical insulation between the conductor and the fitting. Often, this breakdown occurs at several thousand volts AC, which is not an uncommon test requirement for such parts. As such, there is a need to provide a conductor feedthrough that not only maintains a hermetic seal within a pressure vessel, but also provides greater resistance to torque stresses imparted on the feedthrough.

Accordingly, what would be desirable, but has not yet been provided, is a conductor feedthrough that allows an electrical conductor to be passed into a vessel while maintaining a hermetic seal within the vessel and providing resistance to torque stress imparted on the feedthrough.

### SUMMARY OF THE INVENTION

The present invention provides a conductor feedthrough for allowing an electrical conductor, cable, wire, etc., to be passed through a pressurized vessel while maintaining a hermetic seal within the vessel and providing resistance to torque stress imparted on the feedthrough. The mechanism comprises a first epoxy casting, a fitting, and a second epoxy casting. The first epoxy casting is formed annularly about an area of a conductor and sealed thereto. The first casting includes an internal end, an intermediate portion, and a locking portion for engagement with the fitting to lock the conductor in position when the fitting is positioned in an aperture in the wall of the vessel. The fitting is engaged with the first casting in such a manner as to prevent relative rotational movement between the first casting and the fitting. The fitting includes an external end, an insertion end for insertion into a wall of the vessel, and a hexagonal inner surface for engagement with the locking portion of the first casting. Threads can be provided on the insertion end for threading the fitting into an aperture of the wall, or the fitting could be glued or bonded to the wall. An O-ring can be provided on the fitting at the exterior end for forming a seal between the fitting and the vessel wall when the fitting is installed. The fitting further includes an inner cylindrical surface having internal annular channels and O-rings positioned therein. The O-rings maintain a hermetic seal between the intermediate portion of the first casting and the fitting. A second epoxy casting is formed on an end of the locking portion of the first casting, and retains the first casting and conductor in position against the fitting. The feedthrough maintains a hermetic seal within the vessel, and provides resistance against torque stress applied to the feedthrough.

### BRIEF DESCRIPTION OF THE DRAWINGS

Other important objects and features of the invention will be apparent from the following Detailed Description of the Invention taken in connection with the accompanying drawings in which:

FIG. 1a is a side view of a fitting forming part of the conductor feedthrough of the present invention.

FIG. 1b is a view of an external end of the fitting shown in FIG. 1a, and FIG. 1c is a view of an insertion end thereof.

FIG. 1d is a cross-sectional view of the fitting, taken along the line 1-1 of FIG. 1a.

FIG. 2a is a side view of a conductor.

FIG. 2b is a side view showing a first casting applied to the conductor for forming the feedthrough of the present invention.

FIG. 2c is a cross-sectional view, taken along the line 2-2 of FIG. 2b, showing the casting on the conductor.

FIG. 2d is a side view showing engagement of the fitting of the feedthrough of the present invention with the first casting.

FIG. 2e is a side view showing the fitting fully engaged with the first casting of the feedthrough and installed in a wall of a pressure vessel.

FIG. 3 is a cross-sectional view of another embodiment of the first casing of the present invention.

### DETAILED DESCRIPTION OF THE INVENTION

The present invention relates to a conductor feedthrough for allowing an electrical conductor, cable, wire, etc., to be passed through a wall of a pressurized vessel (e.g., a compressor vessel forming part of a refrigeration or air conditioning system) while maintaining a hermetic seal within the vessel and providing resistance to torque stress imparted on the feedthrough. The feedthrough comprises a first casting formed on a portion of a conductor, a fitting engageable with the first casting and inserted into an aperture in a vessel wall, and a second casting formed on an end of the first casting. The feedthrough maintains a hermetic seal within the vessel and locks the conductor in place to provide resistance to mechanical stress and/or torque applied to the feedthrough.

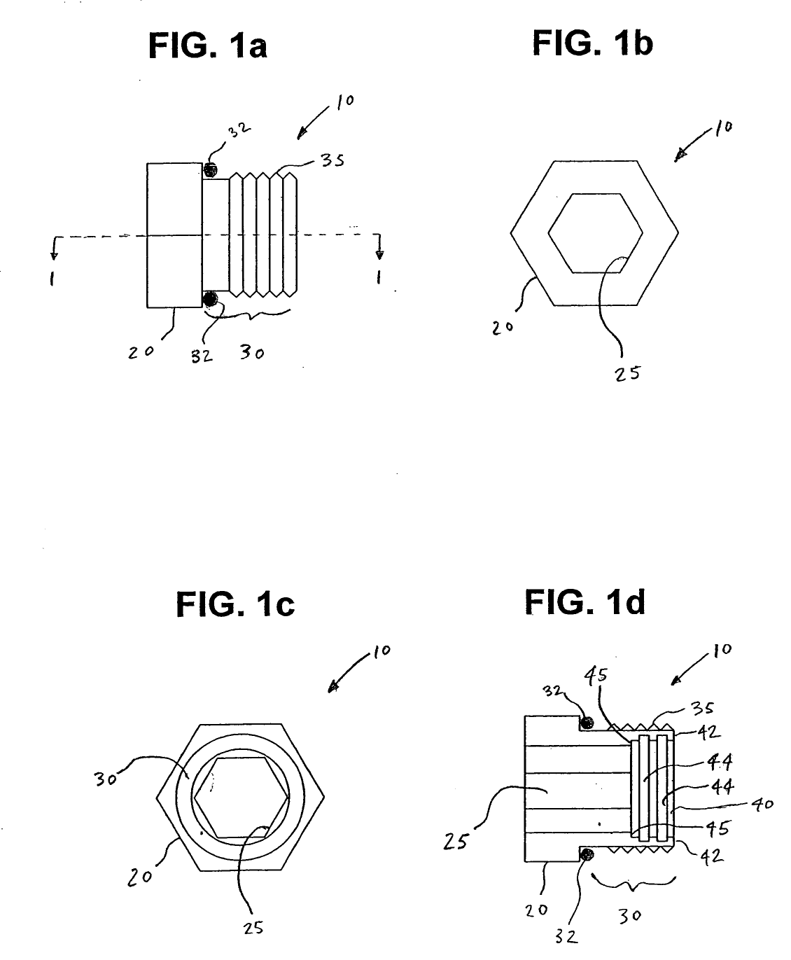

FIG. 1a is a side view of a fitting, indicated generally at 10, forming part of the conductor feedthrough of the present invention. The fitting 10 includes an external end 20 and an insertion end 30. By the term “external,” it is meant a position external to a pressurized vessel. The insertion end 30 is configured to be inserted into an aperture in a vessel wall, and provides a hermetic seal with the wall when inserted. Threads 35 could be provided on the end 30 for threading the fitting 10 into an aperture in the wall, or the end 30 could otherwise be glued or bonded to the wall in any suitable manner known in the art. The external end 20 could have a hexagonal shape for allowing the fitting to be manipulated by a wrench or other device, but any desired shape could be used. An O-ring 32 could be provided at the external end 20 for forming a hermetic seal between the fitting 10 and a vessel wall when the fitting 10 is installed in the wall. The fitting 10 can be formed of brass, stainless steel, or cold-rolled steel, with a corrosion-resistant plating (typically nickel or zinc) applied to the fitting. Additionally, plastic, thermoset, or titanium could be used to form the fitting.

FIGS. 1b and 1c are views of the external end 20 and the insertion end 30, respectively, of the fitting 10 of the present invention. The fitting 10 includes an inner surface 25 that is hexagonal in cross-section and extends partially along the length of the fitting 10, beginning at the external end 20. Importantly, the inner surface 25 engages with the first casting of the feedthrough of the present invention to lock the conductor in place and to provide resistance to torque stress imparted on the feedthrough. The inner surface 25 need not be hexagonal, and in fact, can be of any geometry other than round (e.g., square, pentagonal, octagonal, D-shaped, etc.) could be provided for the inner surface 25.

FIG. 1d is a cross-sectional view of the fitting, taken along the line 1-1 of FIG. 1a. As previously mentioned, the hexagonal-shaped inner surface 25 extends partially along the length of the fitting 10. An inner surface 40 that is round in cross-section is provided along the length of the fitting, at the insertion end 30. A shoulder 45 interconnects the hexagonal and round inner surfaces 25 and 40, respectively. Shoulder can be at a 90 degree angle or less to the axis of the conductor, 15 degrees appears to be optimal. One or more annular channels 44 are formed about the round-shaped inner surface 40, for receiving O-rings for forming a hermetic seal with the first casting. Two channels 44 are shown, each having an O-ring. A peripheral end 42 is formed on the end of the insertion end 30. The O-ring 32 forms a hermetic seal when the fitting 10 is installed in a vessel wall.

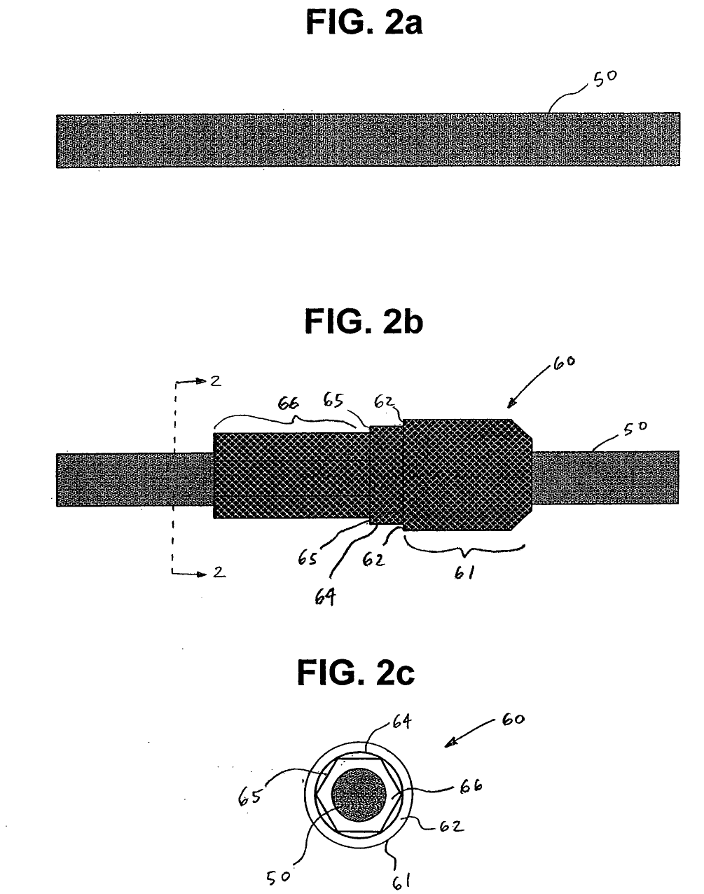

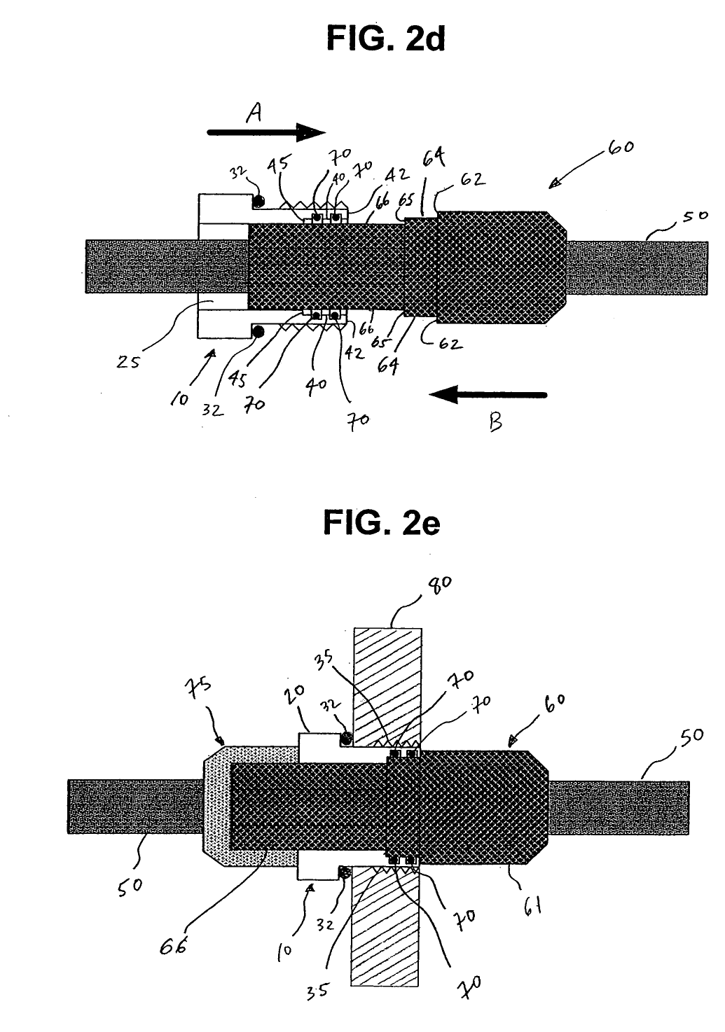

FIG. 2a is a side view showing a conductor, indicated at 50. The conductor could be any electrical, optical or fluid conductor, cable, wire, etc., and could be formed of any suitable material, such as copper. For example, the conductor could be a copper conductor ranging in diameter from 0.25 inches to 1.5 inches. Of course, any desired diameter and construction could be used. Moreover, the conductor could be square in cross-section, or could have any other desired shape.

FIG. 2b is a side view showing the first casting of the feedthrough of the present invention, indicated generally at 60. The first casting 60 is formed around a portion of the conductor 50, and is formed of an epoxy, such as E&C 2850 FT/FR Cat. 9, manufactured by Emerson and Cumming, Inc. (Billerica, Mass.), or other suitable material. When the epoxy cures, the casting 60 bonds to the conductor 50 by a press-fit, forming a hermetic seal therewith. The casting 60 also serves as a dielectric for insulating the conductor 50. The casting 60 includes an internal end 61, an intermediate portion 64, and a locking portion 66. By the term “internal,” it is meant a position within a pressure vessel. The internal end 61 is interconnected with the intermediate portion 64 by shoulder 62. The intermediate portion is interconnected with the locking portion 66 by shoulder 65. Shoulders 62 and 65 serve to prevent “push through” of the casting 60 during high pressure testing and operation of the vessel. The locking portion 66 is hexagonal in shape, and is engageable with the hexagonal-shaped inner surface 25 of the fitting 10. Of course, any suitable shapes capable of preventing rotation of the casting 60 with respect to the fitting 10 can be provided for the locking portion 66 of the casting 60 and the inner surface 25 of the fitting 10 without departing from the spirit or scope of the present invention. The casting 60 could be formed by placing a cast over a portion of the conductor 50, injecting epoxy into the cast, allowing the epoxy to cure, and removing the cast.

FIG. 2c is a cross-sectional view of the first casting 60, taken along the line 2-2 of FIG. 2b. The casting is formed annularly about the conductor 50. The internal end 61 has a larger cross-section than the intermediate portion 64, and is joined to the intermediate portion 64 by shoulder 62. The intermediate portion 64 has a larger cross-section than the locking portion 66, and is joined thereto by shoulder 65. The casting 60 is formed in a single piece. When it cures, it forms a press-fit to the conductor 50 to form a hermetic seal therewith. It should be noted that one or more splines (a fin-like protrusion) could be formed in the conductor 50, to prevent rotation of the conductor 50 with respect to the casting 60.

FIG. 2d is a side view showing engagement of the fitting 10 of the feedthrough of the present invention with the first casting 60. After the casting 60 has been formed on the conductor 50, an end of the conductor 50 is inserted through the fitting 10. The hexagonal-shaped insertion end 66 of the casting 60 mates with the hexagonal-shaped inner surface 25 of the fitting 10. The fitting 10 is slideable along the insertion end 66 of the casting 60, and the casting 60 and fitting 10 can be brought together in the direction shown by arrows A and B. The shoulder 65 of the casting 60 is positioned against the shoulder 45 of the fitting 10. In similar fashion, the shoulder 62 of the casting 60 is positioned against the peripheral end 42 of the fitting 10. The intermediate portion is configured to fit within the space defined by the round-shaped inner surface 40 of the fitting 10. When positioned in such space, O-rings 70 form a hermetic seal between the intermediate portion 64 and the round-shaped inner surface 40, thereby hermetically sealing the casting 60 with the fitting 10.

FIG. 2e is a side view showing the feedthrough of the present invention, showing the fitting 10 fully engaged with the casting 60 and the installed in a wall 80 of a pressure vessel. The O-rings 70 form a hermetic seal between the fitting 10 and the casting 60. The fitting 10 is positioned within an aperture of the wall 60, and is retained in fixed position therein by way of threads 35, or by gluing or bonding. The O-ring 32 of the fitting 10 also forms a hermetic seal with the wall 80. Thus, hermetic seals are formed between the wall 80, the fitting 10, the casting 60, and the conductor 50. A second casting 75 is formed on an end of the locking end 66 of the casting 60 and portion of the conductor 50 external to the wall 80. The second casting 75 locks the first casting 60 in place within the fitting 10, thereby retaining the entire feedthrough and conductor 50 in fixed position with respect to the wall 80 of the vessel. The second casting 75 could be formed in similar fashion as the casting 60, i.e., by way of a cast and epoxy injected into the cast. Moreover, the second casting 75 could be formed of the same material as the first casting 60. Alternatively, instead of a second casting, the device could be finished with a swage or in any other known manner.

Importantly, the hexagonal-shaped locking end 66 of the casting 60, in conjunction with the fitting 10, prevents rotation of the casting 60 and conductor 50 when torque stress is imparted on the conductor 50. This serves to maintain the hermetic seal formed between the wall 80, the fitting 10, the casting 60, and the conductor 50. Accordingly, the feedthrough of the present invention allows the conductor 50 to be passed through the wall 80 to deliver electrical power into a pressure vessel, while maintaining a hermetic seal within the vessel and providing resistance to mechanical stress and torque imparted on the conductor 50. It has been found that the feedthrough of the present invention allows greater than 70 foot-pounds of torque to be applied to the conductor 50 without compromising the hermetic seal.

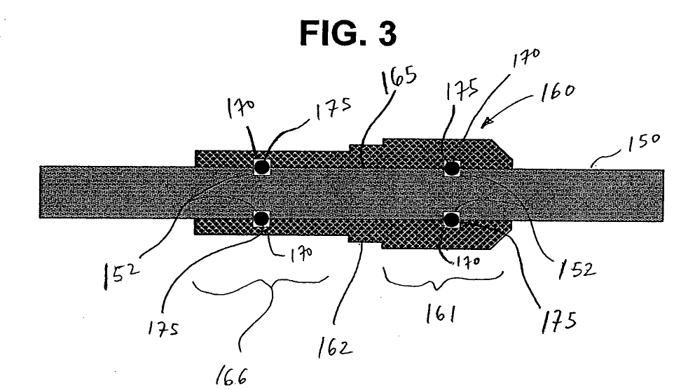

FIG. 3 is a cross-sectional view of another embodiment of the first casting of the present invention, indicated generally at 160. In this embodiment, the casting 160 includes a cylindrical inner surface 165 having annular channels 170, and is formed prior to insertion of the conductor 150 through the casting 160, using any suitable fabrication technique (e.g., injection molding). The annular channels could also be machined. The casting 160 includes a hexagonal locking end 166, similar to the insertion end 66 of casting 60 described earlier, for insertion into the fitting 10 of the present invention, as well as an intermediate portion 162 and internal portion 161. The intermediate portion 162 and internal portion 161 are also similar to the intermediate portion 62 and internal portion 61 of the casting 60, discussed earlier. The round inner surface 165 of the casting 160 abuts the conductor 150. The conductor 150 includes annular channels 152 which correspond to the annular channels 170 of the casting 160 and define spaces wherein O-rings 175 are positioned. The annular channels 152 could be machined into the conductor 150. The conductor 150 can be pushed into the casting 160 and the o-rings 175 positioned in corresponding annular channels in the casting and the conductor to retain the conductor in the casting and to provide a hermetic seal therebetween.

1. A conductor feedthrough comprising:
a first epoxy casting formed annularly about an area of a conductor and sealed thereto;
a fitting engaged with the first casting in such a manner as to prevent relative rotational movement between the first casting and the fitting; and
a second epoxy casting formed on an end of said first casting.

2. The conductor of claim 1 wherein said first casting includes an internal end, an intermediate portion, and a locking portion for engagement with the fitting to lock the conductor in position when the fitting is positioned in an aperture in the wall of the vessel.

3. The conductor of claim 2 wherein said second epoxy casting is formed on an end of the locking portion of the first casting, and retains the first casting and conductor in position against the fitting.

4. The conductor of claim 3 wherein said fitting includes an external end, an insertion end for insertion into a wall of a vessel, and a hexagonal inner surface for engagement with the locking portion of the first casting.

5. The conductor of claim 4 and further comprising threads provided on said insertion end for threading the fitting into an aperture of the wall.

6. The conductor of claim 4 and further comprising means for bonding said fitting into an aperture of the wall to the wall.

7. The conductor of claim 5 and further comprising an O-ring provided on said fitting at the exterior end for forming a seal between the fitting and the vessel wall when the fitting is installed.

8. The conductor of claim 7 wherein said fitting further includes an inner cylindrical surface having internal annular channels and O-rings positioned therein.

9. The conductor of claim 8 wherein said O-rings maintain a hermetic seal between the intermediate portion of the first casting and the fitting.

10. The conductor of claim 3 wherein said conductor maintains a hermetic seal within the vessel, and provides resistance against torque stress applied to the conductor.
